(19) United States
(12) Patent Application Publication
(10) Pub. No.: US 2017/0004511 A1
(43) Pub. Date: Jan. 5, 2017

(54) Identifying Drivers for a Metric-of-Interest

(71) Applicant: Adobe Systems Incorporated, San Jose, CA (US)

(72) Inventors: Shiv Kumar Saini, Rajasthan (IN); Tushar Mehndiratta, Rajpura (IN); Surya Pratap Singh Tanwar, Jaipur (IN); Dhruv Anand, Mumbai (IN)

(21) Appl. No.: 14/788,576

(22) Filed: Jun. 30, 2015

(51) Int. Cl. G06Q 30/02; G06F 17/30; H04L 29/08

(52) U.S. Cl. CPC G06Q 30/0201; H04L 67/02; G06F 17/30604; G06F 17/30867

(57) ABSTRACT

In one or more implementations, data is obtained for metrics that describe visitor interaction with a web site. From these metrics, a user selection is received of a metric-of-interest, which describes a particular visitor interaction with the website. The user selection indicates that driving metrics, which describe visitor interaction that is determined to be influential in causing the particular visitor interaction, are to be identified. Once the metric-of-interest is selected, the data obtained for the website is processed to identify the driving metrics. The processing involves application of a feature selection technique to ascertain candidate driving metrics from the metrics for which the data is obtained. The candidate driving metrics are the metrics likely to be influential in causing the metric-of-interest. The processing also involves application of a statistical causality technique to determine whether the candidate driving metrics are influential in causing the metric-of-interest. The candidate driving metrics that are determined to be influential in causing the metric-of-interest are identified as the driving metrics. A graphical user interface is then generated to present the driving metrics to a user.

### BACKGROUND

Interaction of visitors with websites is increasingly tracked. Not only is visitor interaction tracked for a growing number of websites, but the types of interactions that can be tracked also continues to grow. For example, web analytics techniques collect data on thousands of metrics that describe interactions of visitors with websites, such as a source of a visit, visitor behavior while navigating a website, whether an order is placed, and so on. Web analytics techniques also track and correlate this data to metrics that describe characteristics of individual visitors, such as device information, the browser type used to navigate a website, Internet Protocol (IP) address, past browsing history, and so on. Web analytics are thus capable of providing a wealth of information regarding website interaction.

In the context of commercial websites, businesses may be concerned with improving metrics that reflect their performance, such as orders placed which ties directly to a business's revenue. As part of attempting to improve such metrics, businesses may rely on data analysts to identify visitor interaction that influences those metrics, e.g., so that the businesses can change their practices in ways that affect the identified visitor interaction to improve performance metrics. This can involve the data analysts sifting through the vast amounts of data collected by the web analytics techniques to identify other metrics that reflect the influential visitor interaction. This process can consume significant amounts of data analysts' time, however, and can therefore be costly for businesses. In addition to being time-consuming and costly, this process can be susceptible to error on the part of the data analysts due to spurious correlations and hidden relationships between the metrics. The drawbacks of such techniques for identifying influential metrics for a metric-of-interest render them less than ideal.

### SUMMARY

Identifying drivers for a metric-of-interest is described. In one or more implementations, data is obtained for metrics that describe visitor interaction with a website. For example, the data describes metrics such as, a source of a visit, visitor behavior while navigating the website, whether an order is placed, a browser used to navigate to the website, an Internet Protocol (IP) address of a visitor, past browsing history, and so on. From these metrics, a user selection is received of a metric-of-interest, which describes a particular visitor interaction with the website. The user selection indicates that driving metrics, which describe visitor interaction determined to be influential in causing the particular visitor interaction, are to be identified.

Once the metric-of-interest is selected, the data obtained for the website is processed to identify the driving metrics. The processing involves application of a feature selection technique to ascertain candidate driving metrics from the metrics for which the data is obtained. The candidate driving metrics are the metrics likely to be influential in causing the metric-of-interest. The processing also involves application of a statistical causality technique to determine whether the candidate driving metrics are influential in causing the metric-of-interest. The candidate driving metrics that are determined to be influential in causing the metric-of-interest are identified as the driving metrics. The driving metrics are then presented to a user. By way of example, a graphical user interface is generated that includes a causal relationship graph, which has nodes that represent the metric-of-interest and the driving metrics as well as directed edges that indicate influence of the driving metrics on the metric-of-interest.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of a digital environment in an example implementation that is operable to employ techniques described herein.

FIG. 2 illustrates an example of a causal relationship graph having a first level of driving metrics that are identified for a metric-of-interest.

FIG. 3 illustrates a continuation of the example depicted in FIG. 2 in which the causal relationship graph is modified to include a second level of driving metrics that are identified as influential in causing the first-level driving metrics.

FIG. 4 is an example implementation depicting a user interface for identifying drivers for a metric-of-interest.

FIG. 5 is a flow diagram depicting a procedure in an example implementation in which driving metrics are identified for a metric-of-interest using a feature selection technique and a statistical causality technique.

FIG. 6 is a flow diagram depicting a procedure in an example implementation in which causal relationship graphs are generated for a metric-of-interest in association with a first and second time and in which the causal relationship graphs are compared to determine a difference in influence of driving metrics between the first and second times.

FIG. 7 illustrates an example system including various components of an example device that can be employed for one or more implementations of techniques for identifying drivers for a metric-of-interest that are described herein.

### DETAILED DESCRIPTION

### Overview

Conventional techniques for identifying driving metrics for a metric-of-interest from data that describes the metrics can be time-consuming, costly, and susceptible to error because these techniques involve examination by data analysts. In the context of commercial website analysis, for example, web analytics techniques are capable of collecting a wealth of information in the form of data for metrics that describe user interaction with the websites. The businesses associated with those websites are ultimately concerned with improving the metrics that reflect their performance. By way of example, these businesses may be concerned with improving a metric describing orders placed, which ties directly to revenue of a business. A particular metric with which a user (e.g., such as a business) is concerned is referred to herein as a “metric-of-interest”.

To improve metrics-of-interest, businesses are also concerned with identifying the metrics which describe interactions that influence a metric-of-interest. Those metrics determined to influence metrics-of-interest are referred to herein as “driving metrics”. Once driving metrics are identified, a business may invest its resources to affect the driving metrics in ways that are intended to improve the metric-of-interest. When the driving metrics are wrongly identified, however, a business's investment may not result in a predicted improvement to the metric-of-interest. Because of this, and because conventional driving metric identification techniques can be costly to employ, businesses that use conventional techniques to identify driving metrics may deplete their resources needlessly.

Identifying drivers for a metric-of-interest is described. In one or more implementations, data is obtained for a plurality of metrics. From the plurality of metrics, a user selects a metric-of-interest. Without further user interaction, the techniques described herein then automatically identify from the plurality of metrics the driving metrics that are influential in causing the metric-of-interest. As part of identifying the driving metrics, the techniques described herein are capable of uncovering spurious correlations and hidden relationships between the metrics. Once the driving metrics are identified, they can be presented to the user to inform the user as to which of the plurality of metrics are influential in causing the metric-of-interest.

By way of example, the driving metrics may be presented to the user in a causal relationship graph. A “causal relationship graph” is a time series relationship graph having nodes that represent the metric-of-interest and the driving metrics as well as directed edges that indicate causality. The directed edges of a causal relationship graph indicate causality insofar as a metric represented by a node at the origin of the directed edge is considered to be influential in causing a metric represented by a node at the termination of the directed edge. Further, each of the directed edges has a corresponding weight that indicates an amount of influence origin-node metric imparts on the termination-node metric. The driving metrics may also be presented to a user in other ways, such as listed in a table with a respective amount of influence each of the metrics imparts on the metric-of-influence. Using the techniques described herein, businesses can improve their metrics-of-interest at a lesser cost than business using conventional driving-metric identification techniques.

In the following discussion, an example environment is first described that may employ the techniques described herein. Example implementation details and procedures are then described which may be performed in the example environment as well as other environments. Consequently, performance of the example procedures is not limited to the example environment and the example environment is not limited to performance of the example procedures.

### Example Environment

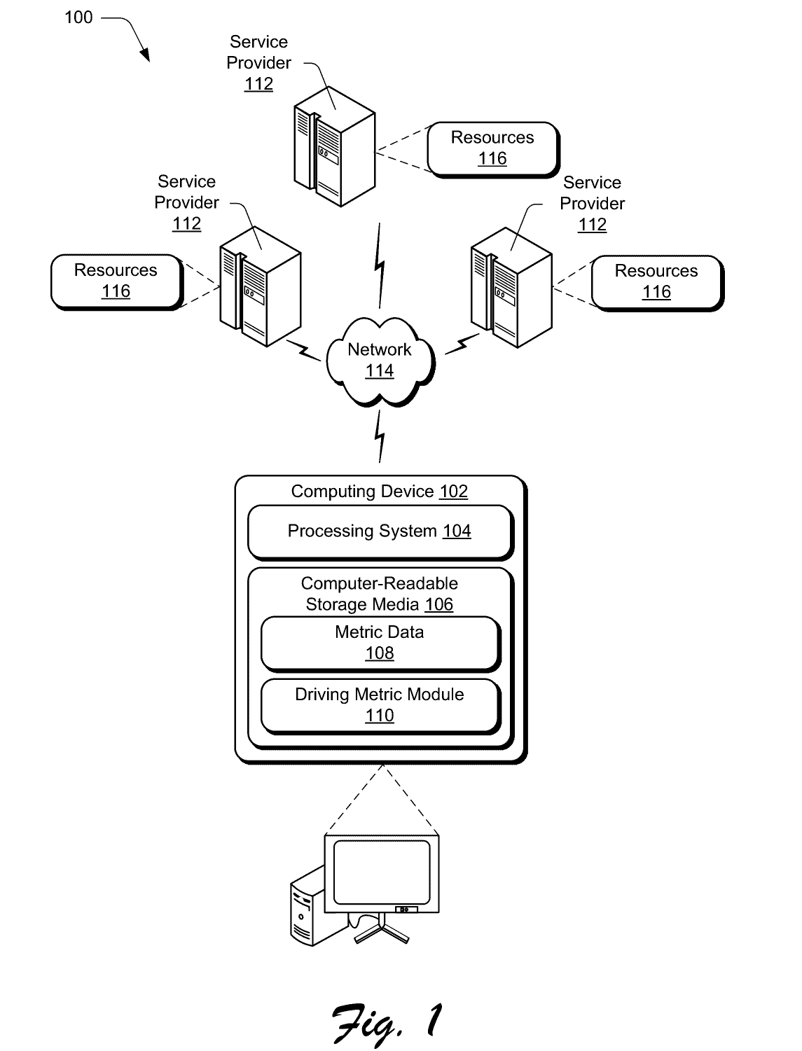

FIG. 1 is an illustration of an environment 100 in an example implementation that is operable to employ techniques described herein. The illustrated environment 100 includes a computing device 102 having a processing system 104 that includes one or more processing devices (e.g., processors) and one or more computer-readable storage media 106. The illustrated environment 100 also includes metric data 108 and a driving metric module 110 embodied on the computer-readable storage media 106 and operable via the processing system 104 to implement corresponding functionality described herein. In at least some implementations, the computing device 102 includes functionality to access various kinds of web-based resources (content and services), interact with online providers, and so forth as described in further detail below.

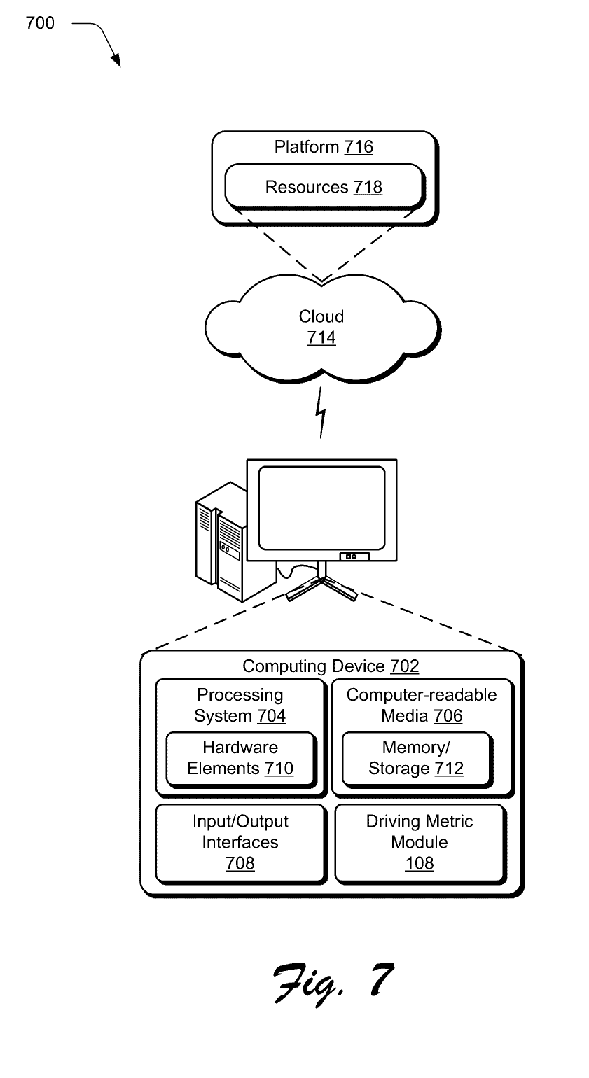

The computing device 102 is configurable as any suitable type of computing device. For example, the computing device 102 may be configured as a server, a desktop computer, a laptop computer, a mobile device (e.g., assuming a handheld configuration such as a tablet or mobile phone), a tablet, a device configured to receive gesture input, a device configured to receive three-dimensional (3D) gestures as input, a device configured to receive speech input, a device configured to receive stylus-based input, a device configured to receive a combination of those inputs, and so forth. Thus, the computing device 102 may range from full resource devices with substantial memory and processor resources (e.g., servers, personal computers, game consoles) to a low-resource device with limited memory and/or processing resources (e.g., mobile devices). Additionally, although a single computing device 102 is shown, the computing device 102 may be representative of a plurality of different devices to perform operations “over the cloud” as further described in relation to FIG. 7.

The environment 100 further depicts one or more service providers 112, configured to communicate with computing device 102 over a network 114, such as the Internet, to provide a “cloud-based” computing environment. Generally speaking, service providers 112 are configured to make various resources 116 available over the network 114 to clients. In some scenarios, users sign up for accounts that are employed to access corresponding resources from a provider. The provider authenticates credentials of a user (e.g., username and password) before granting access to an account and corresponding resources 116. Other resources 116 are made freely available, (e.g., without authentication or account-based access). The resources 116 can include any suitable combination of services and/or content typically made available over a network by one or more providers. By way of example and not limitation, such services include, but are not limited, to web analytics services (e.g., Adobe® Analytics), which can be used by websites (that provide still other services) to track and collect data describing website interaction, such as interactions of visitors with a website (e.g., sources of visits, visitor behavior while navigating websites, whether orders are placed, device information, browsers used to navigate websites, IP addresses, past browsing histories, and so on). Such services can also include those provided by the websites for which data is tracked and collected by the web analytics services. By way of example, the tracked websites can provide online shopping services, social networking services, content creation services, data storage services, and so on.

These services serve as sources from which significant amounts of data describing visitor interaction with websites can be collected. Metric data 108 represents such data, which may be formatted in any of a variety of formats capable of associating values with a given metric. The metric data 108 may have been collected by a web analytics service or by a particular website and then stored. Although the metric data 108 is shown as part of the computer-readable storage media 106, in implementations the metric data 108 may be included as part of a database (not shown). In any case, the metric data 108 is accessible to the driving metric module 110 for performing the techniques described herein.

The driving metric module 110 represents functionality to implement techniques for identifying drivers for a metric-of-interest as described herein. Consider an example in which data is obtained for a plurality of metrics that describe visitor interaction with a website. In this example, a user may select from the plurality of metrics a metric-of-interest which describes particular visitor interaction with the website, e.g., orders placed. This selection indicates that driving metrics, which are determined to be influential in causing the metric-of-interest, are to be identified and presented to the user. Once the user selects a metric-of-interest, the driving metric module 110 is configured in various ways to identify the driving metrics from the plurality of metrics. Moreover, the driving metric module 110 is configured to do so automatically, such that it is performed without receiving user interaction other than the user's selection of the metric-of-interest. The driving metric module 110 is also configured to present the driving metrics to the user in a way that indicates the influence of those metrics in causing the metrics-of-interest.

To identify which of the plurality of metrics are the driving metrics, the driving metric module 110 is configured to process the data for the plurality of metrics. As part of the processing, the driving metric module 110 applies a feature selection technique (e.g., LASSO feature selection) to ascertain which of the plurality of metrics are candidates to be driving metrics. As used herein, the term “candidate driving metric” refers to a metric from the plurality of metrics that, according to the feature selection technique, is likely to be influential in causing the metric-of-interest. The driving metric module 110 also applies a statistical causality technique (e.g., Granger Causality) as part of the processing. The driving metric module 110 applies the statistical causality technique to determine which of the candidate driving metrics are influential in causing the metric-of-interest. The driving metric module 110 identifies the candidate driving metrics that are determined to be influential in causing the metric-of-interest as the driving metrics.

Having identified the driving metrics, the driving metric module 110 generates a user interface to present the driving metrics, and their influence on the metric-of-interest, to a user. By way of example, the driving metric module 110 generates a causal relationship graph, which is a time series relationship graph that includes nodes representative of the metric-of-interest as well as the driving metrics. As used herein the term “time series” refers to a sequence of data points, typically consisting of successive measurements made over a time interval. In the context of data for metrics describing user interaction with a website, a metric such as orders placed can be considered a time series insofar as the number of orders placed on a website can be measured over a given time period, such orders placed in a day, in an hour, and so on. Non-website-centric examples of time series include ocean tides, counts of sunspots, the daily closing value of the Dow Jones Industrial Average, and so on. Time series data have a natural temporal ordering. Considering the example in which data exists to determine orders placed per day, the orders placed have a natural order such that the orders placed for Day 1 are succeeded by orders placed for Day 2, which are succeeded by orders placed for Day 3, and so forth.

Returning to the discussion of characteristics of the causal relationship graph, it also includes directed edges, indicated as arrows between the nodes that indicate a direction of causality. In particular, a directed edge indicates that a metric represented by a node at an origin of the directed edge causes a metric represented by a node at the termination (e.g., the arrow end) of the directed edge. With each of the directed edges, the driving metric module 110 is configured to include a number that indicates an amount that the origin-node metric of the directed edge causes the termination-node metric. The driving metric module 110 is configured to present driving metrics and the influence they impart on a metric-of-influence in still other ways (e.g., in table form) without departing from the spirit or scope of the techniques described herein.

In one or more implementations, the driving metric module 110 is implementable as a software module, a hardware device, or using a combination of software, hardware, firmware, fixed logic circuitry, etc. Further, the driving metric module 110 can be implementable as a standalone component of the computing device 102 as illustrated. In addition or alternatively, the driving metric module 110 can be configured as a component of a web service, an application, an operating system of the computing device 102, a plug-in module, or other device application as further described in relation to FIG. 7.

Having considered an example environment, consider now a discussion of some example details of the techniques for identifying drivers for a metric-of-interest in accordance with one or more implementations.

Identifying Drivers for a Metric-of-Interest

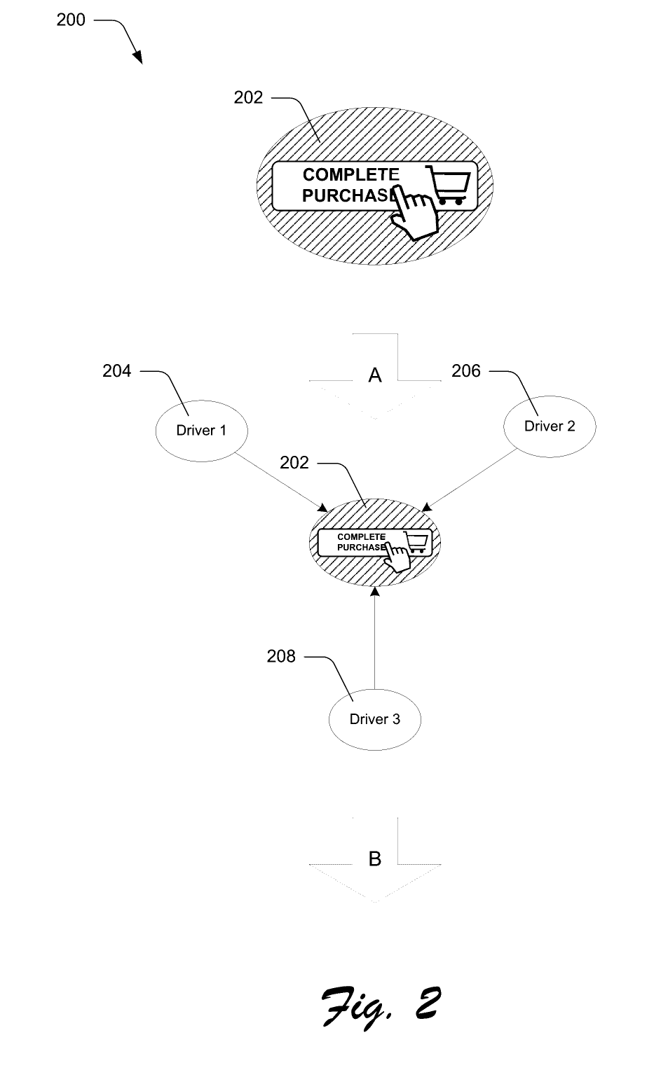

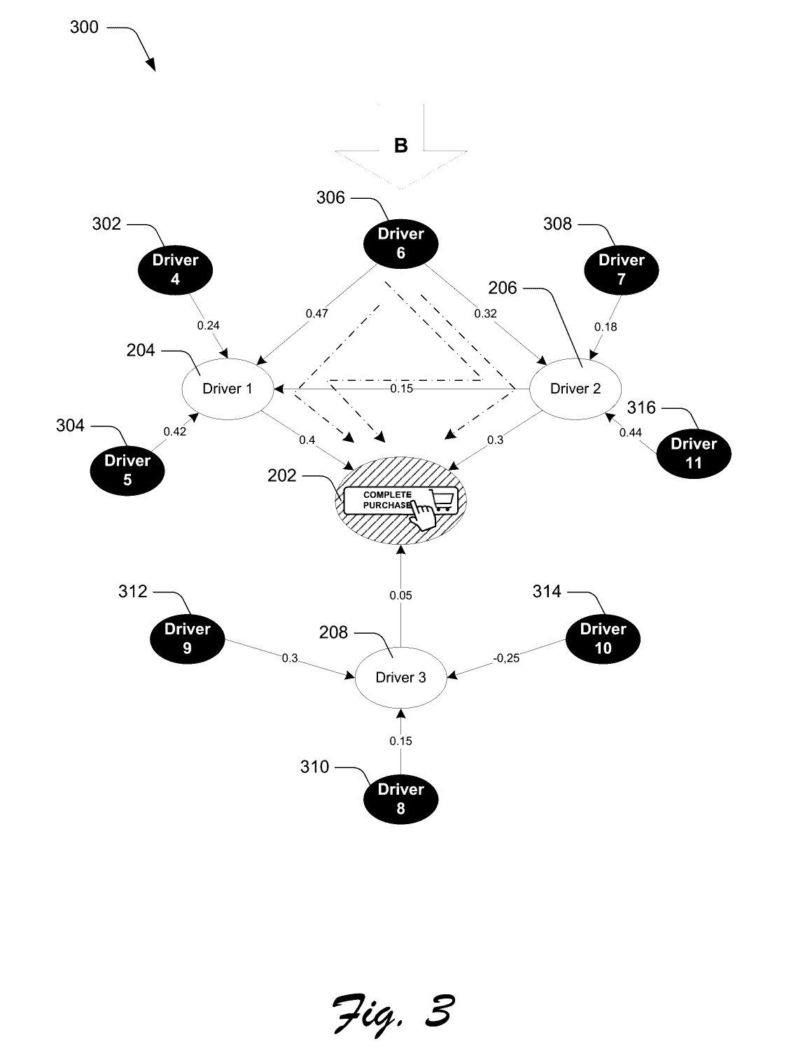

This section describes some example details of techniques for identifying drivers for a metric-of-interest in accordance with one or more implementations. FIG. 2 depicts an example 200 of a causal relationship graph having a first level of driving metrics that are identified as being influential in causing a metric-of-interest. The causal relationship graph depicted in FIGS. 2 and 3 represents an example of a graph that the driving metric module 110 is capable of generating. The causal relationship graph also illustrates aspects that are useful for explaining the techniques described herein.

In the example 200, the causal relationship graph represents a scenario in which a metric-of-interest has been selected by a user from a plurality of metrics that describe visitor interaction with a website. In this scenario, the particular metric-of-interest selected by the user corresponds to “orders placed”, which is represented in a metric-of-interest node 202 through inclusion of a “complete purchase” button with a shopping cart. It is to be appreciated that a user may select any of the plurality of metrics as the metric-of-interest. When the plurality of metrics describe visitor interaction with a website, for example, the user may select metrics-of-interest such as “likes” received, selections made to subscribe to email campaigns, selections made to take advantage of a trial class, and so on.

Arrow “A” of FIG. 2 represents that a first level of driving metrics are identified from the plurality of metrics for the metric-of-interest. The first-level driving metrics, which correspond to “Driver 1”, “Driver 2”, and “Driver 3”, are represented by driving-metric nodes 204, 206, and 208 respectively. Between each of the driving-metric nodes 204, 206, and 208 and the metric-of-interest node 202 is a directed edge which indicates a direction of causality. Each of the directed edges originate from the driving-metric nodes 204, 206, and 208 and terminate at the metric-of-interest node 202, which indicates that Driver 1, Driver 2, and Driver 3 are determined to be influential in causing the metric-of-interest. Broadly speaking, a node at an origin of a directed edge represents a metric that is determined to be influential in causing a metric represented by a node at a termination of the directed edge. In this example, Driver 1, Driver 2, and Driver 3 may correspond to respective metrics that describe time spent on the website, visits that occurred as a result of a search, and product reviews clicked.

FIG. 3 illustrates at 300 a continuation of the example depicted in FIG. 2. In the continued example illustrated at 300, the causal relationship graph is modified to include a second level of driving metrics that are influential in causing the first-level driving metrics. Arrow “B” of FIGS. 2 and 3 represents that driving metrics are identified from the plurality of metrics for the first-level driving metrics, e.g., for the driving metrics represented by the driving-metric nodes 204, 206, and 208. The second-level driving metrics, which correspond to “Driver 4”, “Driver 5”, “Driver 6”, “Driver 7”, “Driver 8”, “Driver 9”, “Driver 10”, and “Driver 11”, are represented by driving-metric nodes 302, 304, 306, 308, 310, 312, 314, and 316, respectively. It should be noted that there is also a directed edge between driving-metric node 206 and driving-metric-node 204. This indicates that Driver 2 is a second-level driving metric that is influential in causing Driver 1.

As between the driving-metric nodes 204, 206, and 208 of the first level and the metric-of-interest node 202, there are also directed edges between the driving-metric nodes 302, 304, 306, 308, 310, 312, 314, and 316 of the second level and the driving-metric nodes 204, 206, and 208 of the first level. The directed edges between the driving-metric nodes 302, 304, 306, 308, 310, 312, 314, and 316 of the second level and the driving-metric nodes 204, 206, and 208 of the first level indicate that Driver 4, Driver 5, Driver 6, Driver 7, Driver 8, Driver 9, Driver 10, and Driver 11 are determined to be influential in causing at least one of Driver 1, Driver 2, or Driver 3, and thus also influential in causing the metric-of-interest.

As noted above, the arrows “A” and “B” represent identification of driving metrics from the plurality of metrics, with arrow “A” representative of identifying first-level driving metrics and arrow “B” representative of identifying second-level driving metrics. To identify driving metrics from a plurality of metrics, the driving metric module 110 processes the data for the plurality of metrics according to a feature selection technique and a statistical causality technique.

By way of example, processing the data for the plurality of metrics to identify the driving metrics involves application of LASSO feature selection and Granger Causality. Conventional techniques that combine LASSO feature selection with Granger Causality are referred to as Granger LASSO approaches. Generally, application of a Granger LASSO approach involves performing feature selection on the lags of a dependent variable (e.g., a metric-of-interest) and the lags of another time series (e.g., one of the plurality of metrics). As discussed above, a “time series” is a sequence of data points, typically consisting of successive measurements made over a time interval. The term “lag” refers to a value of a metric measured at a time that precedes a time associated with the value of the metric under consideration. For example, in a time series X={X₁, X₂, X₃, . . . }, 1, 2, and 3 represent a first time, a second time, and a third time that a measurement for the metric X was taken. In the context of website metrics, the terms X₁, X₂, and X₃ may correspond to orders placed on a first day, second day, and third day respectively. Regarding “lags”, X₂ is a lag of X₃, and X₁ is a lag of X₂. Further, both X₁ and X₂ are lags of X₃.

Fundamental to the concept of Granger Causality is the notion that a cause occurs before a corresponding effect and the notion that the cause has unique information about the future value of effects. These notions can be tested by building two models—a first model of the form E(Yₜ|Yₜ₋₁, Yₜ₋₂) where Yₜ represents the value of a dependent variable (e.g., metric-of-interest) at time t and Yₜ₋₁ and Yₜ₋₂ represent lags of the dependent variable, and a second model of the form E (Yₜ|Yₜ₋₁, Yₜ₋₂, . . . xₜ₋₁, xₜ₋₂) where xₜ₋₁ and xₜ₋₂ represent lags of another time series (e.g., one of the plurality of metrics). Conventional techniques that employ the Granger LASSO approach build just the second model, however. Consequently, conventional approaches do not strictly adhere to the notions fundamental to Granger Causality. Moreover, building just the second model for temporal data having high correlation between time series can result in selection of metrics that are not as influential as other metrics in causing a metric-of-interest. This is because the Granger LASSO approach, when applied conventionally, can result in identification of metrics that are highly correlated with each other. However, this is not a desirable property for driving metrics because it causes the information content in each of the driving metrics not to be unique. Since metrics describing website interaction generally are highly correlated, conventional techniques that employ the Granger LASSO approach may be unsuitable for identifying driving metrics from data for those metrics.

In contrast to conventional approaches, the driving metric module 110 applies LASSO feature selection and Granger Causality to build two models. By doing so, the driving metric module 110 identifies driving metrics that provide unique information about a metric-of-interest. In the discussion that follows about the two models, the term Yₜ represents a value of a metric-of-interest at time t, and Xₜ={x_{1,t}, x_{2,t}, x_{3,t}, x_{3,t}, . . . , x_{n,t}} represents a set of potential driving metrics (e.g., the plurality of metrics for which data is collected), such that x_{1,t} represents a value of a first metric of the plurality at time t, n represents the number of metrics in the plurality so that the term x_{n,t} represents a value of a last metric of the plurality. The driving metric module 110 builds the first model according to the following:

E(Yₜ|Yₜ₋₁,Yₜ₋₂, . . . ,Yₜ₋₇)

This expression indicates that the first model is a regression of the metric-of-interest Yₜ at time t on the lags of the metric-of-interest, e.g., Yₜ₋₁, Yₜ₋₂, . . . , Yₜ₋₇. The driving metric module 110 employs LASSO feature selection to choose the lags of the metric-of-interest. LASSO feature selection will select a subset of lags (e.g. Yₜ₋₁, Yₜ₋₄). Given the first model, the driving metric module 110 estimates the residuals of the metric-of-interest. The term “residuals” refers to a deviation of an observed value of a metric from its theoretical value. In particular, a residual of a metric's observed value is a difference between the metric's observed value and the metric's estimated function value. The driving metric module 110 estimates the residuals for the metric-of-interest according to the following:

dYₜ=Yₜ−E(Yₜ|Yₜ₋₁,Yₜ₋₂, . . . ,Yₜ₋₇)

Here, Yₜ again represents the metric-of-interest at time t (e.g., the observed value), E(Yₜ|Yₜ₋₁, Yₜ₋₂, . . . , Yₜ₋₇) represents the regression of the metric-of-interest as calculated above (e.g., the estimated value), and dYₜ represents the difference between those values (e.g., the residual). Given the residuals of the metric-of-interest, the driving metric module 110 builds the second model according to the following:

E(dYₜ|Yₜ₋₁,Yₜ₋₂, . . . ,xₜ₋₁,xₜ₋₂, . . . )

This expression indicates that the second model is a regression of the residuals of the metric-of-interest dYₜ on the lags of the metric-of-interest Yₜ and the lags of the set of potential driving metrics Xₜ. The driving metric module 110 ascertains the lags of the metric-of-interest Yₜ and the lags of the set of potential driving metrics Xₜ by applying LASSO feature selection to the data obtained for the plurality of metrics. The subset of metrics chosen according to LASSO feature selection is represented by the term X_{y}. The result of the choosing can reduce the number of metrics under consideration from thousands (e.g., each of the plurality of metrics) to fewer than ten metrics. The chosen subset of metrics X_{y} are the candidate driving metrics. Application of LASSO feature selection results in choosing candidate driving metrics that are likely to be influential in causing the metric-of-influence. These metrics are merely candidate driving metrics, however. If it is determined that the second model, which indicates unique causation by the candidate driving metrics, is not a closer fit to the observed data than the first model, then the candidate driving metrics chosen to build the second model are determined not to be driving metrics. In this instance, the driving metric module 110 employs LASSO feature selection to choose lags for a different subset of metrics, and rebuilds the second model.

To determine whether the first model or second model is a closer fit to the observed data, the driving metric module 110 compares the first and second model by applying Granger Causality. To do so, the driving metric module 110 computes a Bayesian information criterion (BIC) for the models. Generally, a model having a lower BIC is determined to be a closer fit with observed data. Thus, if the BIC of the first model is less than or equal to the BIC of the second model, then the subset of metrics chosen according to LASSO feature selection X_{y} for building the second model is determined not to be influential in causing the metric-of-interest. However, if the BIC of the first model is greater than the BIC of the second model, then the subset of metrics chosen according to LASSO feature selection X_{y} for building the second model is determined to be influential in causing the metric-of-interest. When the BIC of the first model is greater than the BIC of the second model, the driving metric module 110 identifies the subset of metrics chosen according to LASSO feature selection X_{y} as the driving metrics for the metric-of-interest.

The processing of data just outlined is described with reference to identification of driving metrics for the metric-of-interest. In other words, the just-outlined processing identifies first-level driving metrics for the metric-of-interest. To identify second-level driving metrics the processing is performed in a similar manner. Rather than building models for regressions of the metric-of-interest and residuals of the metric-of-interest, however, models are built for each of the first-level driving metrics, such that for each first-level driving metric a model is built for a regression of the given first-level driving metric and a model is built for a regression of the residuals of the given first-level driving metric. The driving metric module 110 then identifies the second-level driving metrics for each of the first-level driving metrics by applying Granger Causality to the models built for the first-level driving metrics. It is to be appreciated processing may be performed in this manner for any number of levels of driving metrics. A user may, for example, select a number of levels for which driving metrics are to be identified.

Given identification of the driving metrics (e.g., a first level of driving metric and a second level of driving metrics), the driving metric module 110 can construct a causal relationship graph. To do so, the driving metric module 110 inserts a node into the graph for the metric-of-interest and nodes for at least a first level of driving metrics. As mentioned above, the first-level driving-metric nodes are connected to the metric-of-interest node by directed edges, which indicate that the first-level driving metrics cause the metric-of-interest. For any subsequent levels of driving metrics identified, the nodes representative of these metrics are connected to corresponding nodes of the preceding level to indicate that the metrics of the subsequent level are influential in causing the metrics of the preceding level.

Returning to the discussion of the causal relationship graph depicted in FIG. 3, each of the directed edges in the illustrated example is depicted with a corresponding number. The directed edge between the driving-metric node 306 and the driving-metric node 204, for instance, is depicted with the number 0.47. These numbers are weights indicative of an amount that the metric represented by the node at the origin of the directed edge causes the metric represented by the node at the termination of the directed edge. The driving metric module 110 may compute these weights based on an analysis of the data obtained for the plurality of metrics. The weight of a directed edge indicates the change in the termination-node metric that results from a 1-unit change in the origin-node metric, with other conditions remaining the same.

Given a causal relationship graph, the driving metric module 110 is configured to calculate the influence of the driving metrics on the metric-of-influence. Based on the calculated influence, the driving metric module 110 indicates which of the driving metrics are most influential in causing the metric-of-interest, e.g., by listing the driving metrics in order of the amount they influence the driving metric.

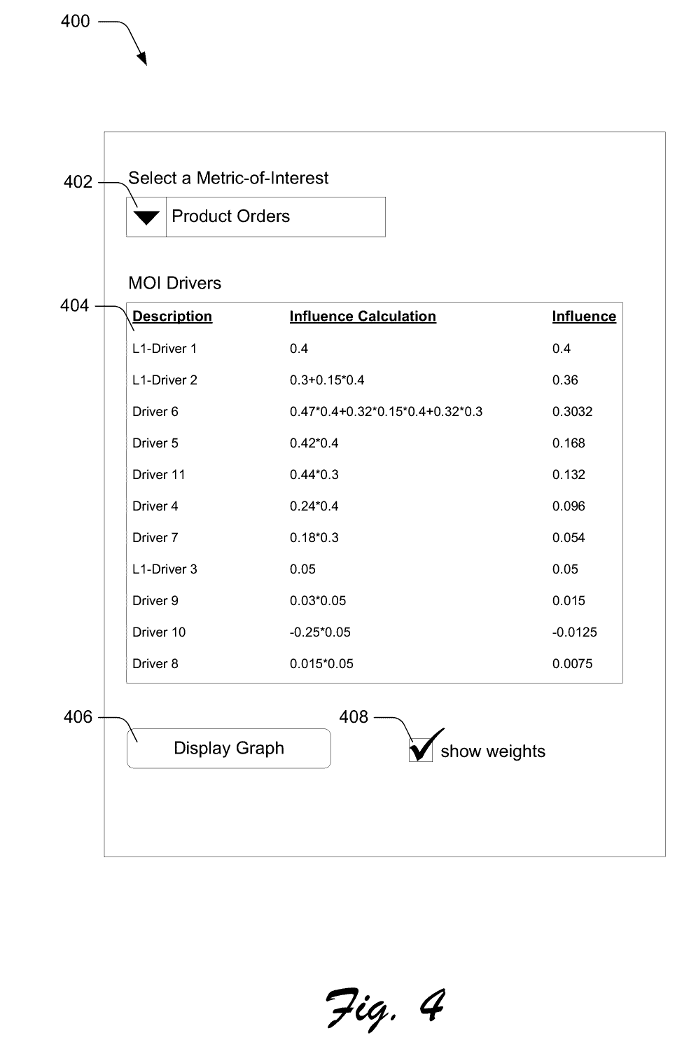

FIG. 4 depicts an example user interface 400 for identifying drivers for a metric-of-interest. In particular, FIG. 4 depicts a user interface associated with the causal relationship graph of FIGS. 2 and 3, and includes a metric-of-interest selection component 402, a list 404 of the driving metrics, a display graph component 406, and a show weights selection component 408. The list 404 lists the driving metrics associated with the causal relationship graph of FIGS. 2 and 3 in order of an amount they influence the metric-of-influence.

To calculate the amount that a given driving metric influences a metric-of-interest, the driving metric module 110 adds and multiplies weights of any directed edges in the graph from the node representing the given driving metric to the metric-of-interest node 202. Consider, for example, the driving metric “Driver 6”, which is represented by the driving-metric node 306. To calculate the influence that Driver 6 has on the metric-of-influence (orders placed), the driving metric module 110 considers each path from its representative node to the metric-of-interest node 202. For each path, the driving metric module 110 multiplies the weights the corresponding directed edges along the path to result in a path weight. The driving metric module 110 then adds the path weights for each path to result in the influence that the represented node imparts on the metric-of-influence.

In the particular example of Driver 6, there are three different paths from its representative node, the driving-metric node 306, to the metric-of-interest node 202. These paths are represented in FIG. 3 using the dashed lines. A first path starts at the driving-metric node 306 and connects to the metric-of-interest node 202 through the driving-metric node 206. The directed edge between the driving-metric node 306 and the driving-metric node 206 has a weight of 0.32 and the directed edge between the driving-metric node 206 and the metric-of-interest node 202 has a weight of 0.3. The path weight of this first path is calculated by multiplying 0.32 by 0.3 and is thus 0.096. A second path starts at the driving-metric node 306 and connects to the metric-of-interest node 202 through the driving-metric node 204. The directed edge between the driving-metric node 306 and the driving-metric node 204 has a weight of 0.47 and the directed edge between the driving-metric node 204 and the metric-of-interest node 202 has a weight of 0.4. The path weight of this second path is calculated by multiplying 0.47 by 0.4 and is thus 0.188. A third path starts at the driving-metric node 306 and connects to the metric-of-interest node 202 through the driving-metric node 206 and then through the driving-metric node 204. The directed edge between the driving-metric node 306 and the driving-metric node 206 has a weight of 0.47, the directed edge between the driving-metric node 206 and the driving-metric node 204 has a weight of 0.15, and the directed edge between the driving-metric node 204 and the metric-of-interest node 202 has a weight of 0.4. The path weight of this third path is calculated by multiplying 0.32 by 0.15 and 0.4, and is thus 0.0192. The driving metric module 110 then adds the path weights for the first, second, and third paths, which are 0.096, 0.188, and 0.0192, respectively, to obtain the influence of Driver 6 on the metric-of-interest, which is 0.3032.

The driving metric module 110 is configured to compute the influence of the other driving metrics on the metric-of-interest using the causal relationship graph in a similar manner. The list 404 of the user interface depicted in FIG. 4 includes indications of these influence calculations performed by the driving metric module 110. In one or more implementations, the driving metric module 110 may generate a user interface to indicate the influence of the driving metric on the metric-of-influence without including indications of the calculations. In any case, the amount of influence shown in the list 404 and the ordering of the driving metrics indicates which of the driving metrics are determined to be most influential in causing the metric-of-interest.

With regard to other features of a user interface for presenting the driving metrics, the display graph component 406 is selectable to display a causal relationship graph for the metric-of-interest, such as that depicted in FIG. 3. The causal relationship graph may indicate weights of the directed edges when the show weights selection component 408 is selected. In other implementations, the user interface may not include the show weights selection component 408 and may show the weights of the directed edges by default. When the user interface depicts the causal relationship graph, a driving node may be selectable to highlight one or more paths from the driving node to the metric-of-interest node 202.

In one or more implementations, the driving nodes may be color-coded to indicate an amount of influence the represented driving metrics impart on the metric-of-interest. For example, nodes representative of metrics that impart more influence than other metrics may be colored red or orange, indicating that those nodes are “hot”. In contrast, nodes representative of metrics that impart less influence than other nodes may be colored green, blue, purple, and so on, indicating that those nodes are “cold”. A causal relationship graph may be displayed in still other ways to indicate influence of the driving metrics on the metric-of-interest. By doing so, a website analyst may be able to quickly look at a causal relationship graph generated in this way and understand which visitor interaction or interactions are most influential in causing the visitor interaction represented by the metric-of-interest.

Although not shown, the user interface 400 may also include a component that allows a user to select a number of levels of driving nodes that are to be identified for the metric-of-interest. Further, although the display graph component 406 is illustrated as a dropdown box it may be configured as any other component that allows a user to select one of the plurality of metrics as the metric-of-interest. Similarly, the display graph component 406 may be configured as a component other than a button (as depicted) and the show weights selection component 408 configured as a component other than a checkbox (as depicted) without departing from the spirit or the scope of the techniques herein.

In addition to computing influence of driving metrics using a particular causal relationship graph, the driving metric module 110 can determine changes in the influence of driving metrics over time using multiple causal relationship graphs. By way of example, the driving metric module 110 may generate a causal relationship graph that indicates the driving metrics associated with a first time for the metric-of-interest, and a second causal relationship graph that indicates the driving metrics associated with a second time for the metric-of-interest. The driving metric module 110 can then compare the causal relationship graphs generated for the first and second times to determine whether the graphs include different driving metrics, different weights of directed edges, and so forth.

To compare causal relationship graphs generated in association with a metric-of-interest measured at different times, the driving metric module 110 is configured to track changes between the causal relationship graphs. Consider a scenario in which the driving metric module 110 generates a first causal relationship graph G(t) for a metric-of-interest measurement associated with a first time period t. In this scenario, the driving metric module 110 also generates a second causal relationship graph G(t+1) for a measurement of the metric-of-interest that is associated with a second time period t+1. Assume, for the purpose of illustration, that O₁ₜ, O₂ₜ, . . . , Oₙₜ are nodes present in the first causal relationship graph G (t) but not in the second causal relationship graph G (t+1). In other words, the driving metric module 110 has identified, for the metric-of-interest over the first time period t, driving metrics represented by nodes O₁ₜ, O₂ₜ, . . . , Oₙₜ that are not identified for the metric-of-interest over the second time period t+1. Also assume for the purpose of illustration that N₁ₜ, N₂ₜ, . . . , Nₙₜ are nodes present in the second causal relationship graph G(t+1) but not in the first causal relationship graph G(t). This indicates that the driving metric module 110 has identified, for the metric-of-interest over the second time period t+1, driving metrics represented by nodes N₁ₜ, N₂ₜ, . . . , Nₙₜ that are not identified for the metric-of-interest over the first time period t.

As noted above, the driving metric module 110 can compute the influence of each driving metric on a metric-of-interest by computing path weights for each path from a node representative of the driving metric to the metric-of-interest node. When comparing causal relationship graphs, the driving metric module 110 computes the influence of each driving metric represented. The driving metric module 110 is configured to use these influences to compute the change in influence of the driving metrics on the metric-of-interest from the first time period t to the second time t+1 period as follows:

|I(O₁ₜ)|+|(O₂ₜ)|+ . . . +|I(Oₙₜ)|+|I(N₁ₜ)|+|I(N₂ₜ)|+ . . . +|I(Nₙₜ)|

Here, I (Node i) represents the influence of the driving metric represented by Node i on the metric-of-interest. Having computed an amount that the influence of different driving metrics changes between the first time period and a second time period, the driving metric module 110 can present this change to a user, e.g., via a user interface.

Identifying driving metrics for a metric-of-interest from data for a plurality of metrics that describe interaction with a website enables an analyst to simply select a metric that is believed indicate website or business performance, and have the driving metrics automatically identified and presented. The analyst can also consider business practices changed between a first time and a second time and look at the generated user interface (e.g., including one or more causal relationship graphs, tables that indicate influence of driving metrics, or a presented influence change) to see whether and how much the changed business practices affected the driving metrics (e.g., which of the plurality of metrics are driving metrics and an amount of influence imparted by the driving metrics), and thus the metric-of-interest. Given this, analysts can suggest implementing business changes to affect driving metrics in a way that improves the metric-of-interest. Moreover, the techniques described herein enable an analyst to be presented with information indicating how such changes affect the driving metrics and their influence on the metric-of-interest.

Having discussed example details of the techniques for identifying drivers for a metric-of-interest, consider now some example procedures to illustrate additional aspects of the techniques.

### Example Procedures

This section describes example procedures for identifying drivers for a metric-of-interest in one or more implementations. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks. In at least some implementations the procedures are performed by a suitably configured device, such as the example computing device 102 of FIG. 1 that makes use of a driving metric module 110.

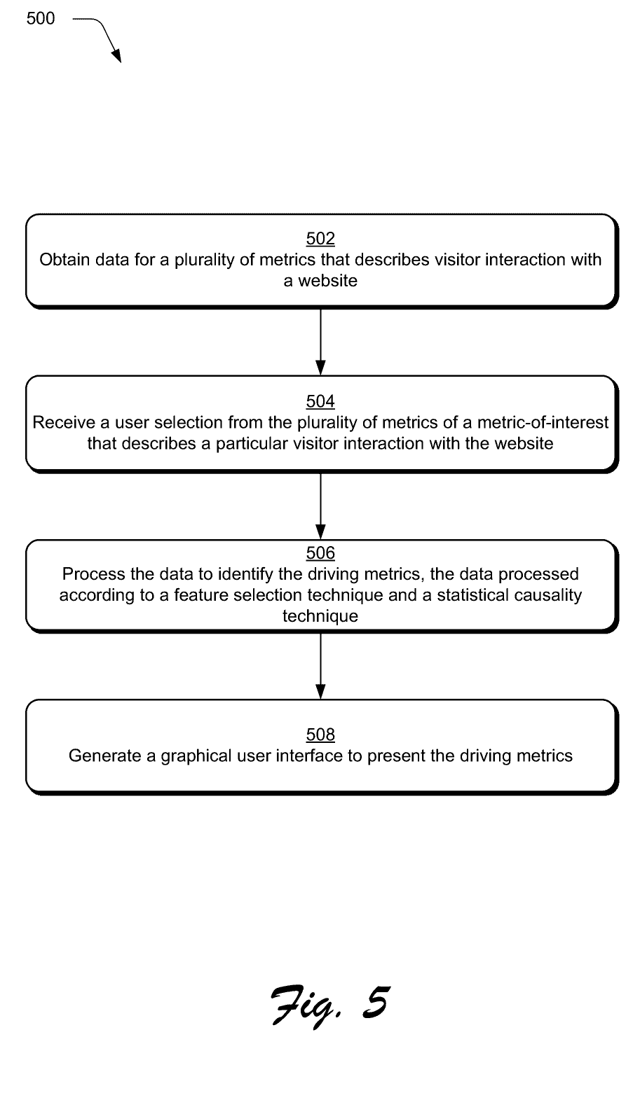

FIG. 5 depicts an example procedure 500 in which driving metrics are identified for a metric-of-interest using a feature selection technique and a statistical causality technique. Data is obtained for a plurality of metrics that describes visitor interaction with a website (block 502). For example, the driving metric module 110 obtains the metric data 108, which describes interaction of website visitors with a website, e.g., one provided by one of the service providers 112. The metric data 108 may have been collected over some period of time using web analytics techniques and describes the interaction of visitors with the web site over that time. Further, the metric data 108 may take the form of a plurality of metrics where each metric represents a different interaction, characteristic of a visitor that interacts with the website, and so on. For example, the metric data 108 may describe metrics such as aggregate metrics for an entire website (e.g., page views, bookings, entries, unique visitors, and so on), segmented metrics that describe aggregates for particular segments (e.g., orders by social networking website visitor, orders by marketing channel, and so on), and dimension-element metrics which enable each aggregate metric to be divided in to elements by metric value (e.g., country of visit, social platform, device type, and so on).

Additionally, each time data is collected for a particular metric it can be associated with an indication of the time, such as a timestamp. In this way, a metric may be tracked over time. Consider a metric that describes orders placed on a website. Each item of data that describes orders place can be associated with a time such that a number of orders placed can be determined for a day, for a week, for a month, and so forth. By tracking metrics, such as orders placed, over time a time series of data is created for each of the individual metrics.

A user selection is received from the plurality of metrics of a metric-of-interest that describes a particular visitor interaction with the website (block 504). The user selection indicates that for the metric-of-interest driving metrics are to be identified which describe other visitor interaction with the website that is influential in causing the particular visitor interaction. By way of example, the driving metric module 110 populates the metric-of-interest selection component 402 with options that enable each of the plurality of metrics to be selected. Using the metric-of-interest selection component 402, the user selects one of the plurality of metrics as the metric-of-interest, e.g., by clicking on the metric.

Once the metric-of-interest is selected, the data for the plurality of metrics is processed to identify the driving metrics (block 506). In particular, the data is processed according to a feature selection technique to ascertain from the plurality of metrics candidate driving metrics that are likely to be influential in causing the metric-of-interest. The data is also processed according to a statistical causality technique to identify the candidate driving metrics that are determined to be influential in causing the metric-of-interest as the driving metrics.

For example, the driving metric module 110 processes the metric data 108 according to LASSO feature selection to ascertain candidate driving metrics that are likely to be influential in causing the metric-of-interest. As part of processing the data, the driving metric module 110 builds two models as described in more detail above, one of which is built using the time series data of the candidate driving metrics. The driving metric module 110 then uses Granger Causality to determine whether the candidate driving metrics are influential in causing the metric-of-interest and are thus to be identified as driving metrics. In particular, the driving metric module 110 compares the two models using Granger Causality. If the comparison indicates that the model built using the time series data of the candidate driving metrics fits the data closer than the other model, then the driving metric module 110 identifies the candidate driving metrics as the driving metrics. Otherwise the driving metric module 110 again applies LASSO feature selection to ascertain other candidate driving metrics.

A graphical user interface is generated to present the driving metrics (block 508). By way of example, the driving metric module 110 generates the user interface 400 depicted in FIG. 4. The driving metrics may be presented to the user in list form, as illustrated in FIG. 4. As also illustrated in FIG. 4, the driving metrics may be presented with a corresponding amount that they influence the metric-of-influence and in order of the amount they influence the metric-of-interest. In addition or alternately, the driving metric module 110 may present the driving metrics in a user interface that includes a causal relationship graph, such as the causal relationship graph depicted in FIGS. 2 and 3. The driving metric module 110 may generate the causal relationship graph for display responsive to selection by a user of the display graph component 406.

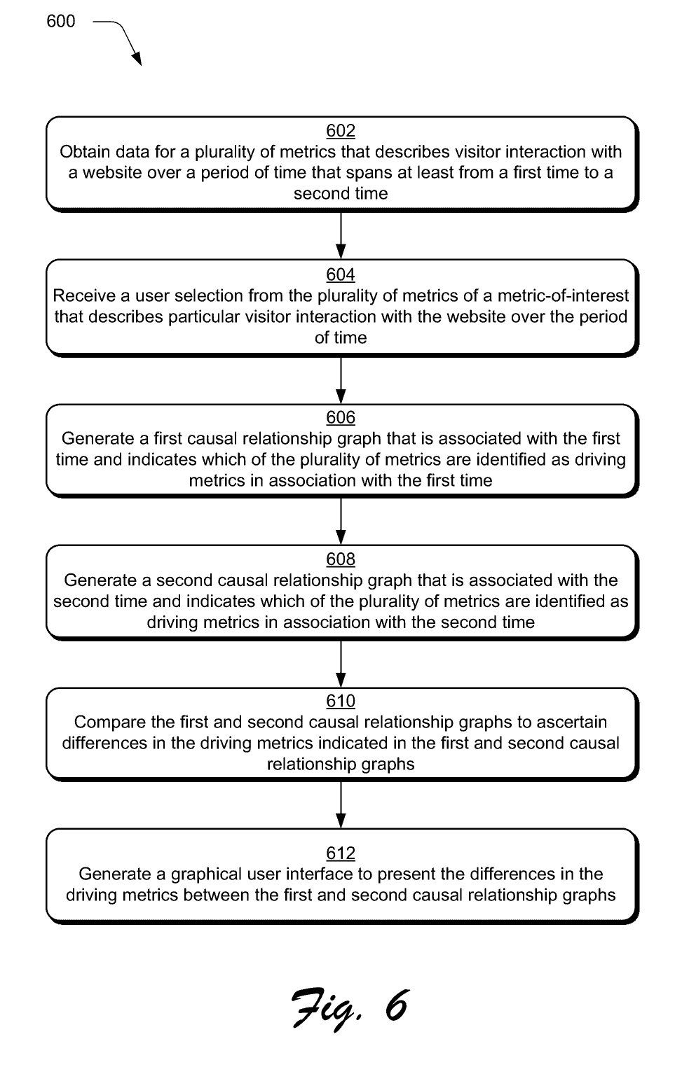

FIG. 6 depicts an example procedure 600 in which causal relationship graphs are generated for a metric-of-interest in association with a first and second time and in which the causal relationship graphs are compared to determine a difference in influence of driving metrics between the first and second times.

Data is obtained for a plurality of metrics that describes visitor interaction with a website over a period of time that spans at least from a first time to a second time (block 602). For example, the driving metric module 110 obtains the metric data 108 that describes visitor interaction with the website over the period of time. A user selection is received from the plurality of metrics of a metric-of-interest that describes a particular visitor interaction with the website over the period of time (block 604). For example, a user selects one of the plurality of metrics as the metric-of-interest using the metric-of-interest selection component 402. In one or more implementations, the user may also select a component (not shown) that indicates that the user would like to see changes to the driving metrics for the metric-of-interest over the time period. Such a component may allow the user to select the first time (e.g., a first date) and the second time (e.g., a second date) for which driving metrics are to be identified for the metric-of-interest.

Given the metric-of-interest and the first time, a first causal relationship graph is generated that is associated with the first time and indicates which of the plurality of metrics are identified as driving metrics in association with the first time (block 606). For example, the driving metric module 110 constructs the first causal relationship graph for a value of the metric-of-interest that corresponds to the first time. The driving metric module 110 may do so, in part, by identifying the driving metrics for the metric-of-interest at the first time as in block 506 of FIG. 5. The first causal relationship graph indicates the driving metrics that are identified as being influential in causing the metric-of-interest at the first time.

A second causal relationship graph is generated that is associated with the second time and indicates which of the plurality of metrics are identified as driving metrics in association with the second time (block 608). For example, the driving metric module 110 constructs the second causal relationship graph for a value of the metric-of-interest that corresponds to the second time. The driving metric module 110 may do so, in part, by identifying the driving metrics for the metric-of-interest at the second time as in block 506. The second causal relationship graph indicates the driving metrics that are identified as being influential in causing the metric-of-interest at the second time.

The first and second causal relationship graphs are compared to ascertain differences in the driving metrics indicated in the first and second causal relationship graphs (block 610). By way of example, the driving metric module 110 compares the first causal relationship graph generated at block 606 to the second causal relationship graph generated at block 608. As part of doing so, the driving metric module 110 ascertains driving metrics that are represented in the first causal relationship graph, but are not represented in the second causal relationship graph. The driving metric module 110 also ascertains driving metrics that are represented in the second causal relationship graph, but are not represented in the first causal relationship graph. The driving metric module 110 may also compare the first and second causal relationship graphs to obtain other differences without departing from the spirit or the scope of the techniques described herein.

Based on the comparison, a graphical user interface is generated to present the differences in the driving metrics between the first and the second causal relationship graphs (block 612). By way of example, the driving metric module 110 generates side-by-side tables for the first causal relationship graph and the second causal relationship graph that indicate the driving metrics identified for each graph. These tables may include highlighting that indicates driving metrics that were not identified for the other causal relationship graph. In one or more implementations, the driving metric module 110 may simply list the driving metrics that were identified for one but not both causal relationship graphs. Still further, the driving metric module 110 may indicate the differences by presenting both the first and second causal relationship graphs and indicating the differences, e.g., via highlighting, animation, and so on.

Having described example procedures in accordance with one or more implementations, consider now an example system and device that can be utilized to implement the various techniques described herein.

### Example System and Device

FIG. 7 illustrates an example system generally at 700 that includes an example computing device 702 that is representative of one or more computing systems and/or devices that implement the various techniques described herein. This is illustrated through inclusion of the driving metric module 110, which operates as described above. The computing device 702 may be, for example, a server of a service provider, a device associated with a client (e.g., a client device), an on-chip system, and/or any other suitable computing device or computing system.

The example computing device 702 includes a processing system 704, one or more computer-readable media 706, and one or more I/O interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This includes implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information for access by a computer.

“Computer-readable signal media” refers to a signal-bearing medium that is configured to transmit instructions to the hardware of the computing device 702, such as via a network. Signal media typically embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that is employed in some implementations to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules are implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software are achieved at least partially in hardware, e.g., through use of computer-readable storage media and/or hardware elements 710 of the processing system 704. The instructions and/or functions are executable/operable by one or more articles of manufacture (for example, one or more computing devices 702 and/or processing systems 704) to implement techniques, modules, and examples described herein.

The techniques described herein are supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device implementation, implementation of functionality described herein is distributed throughout the system 700. For example, the functionality is implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computing device to indicate which of a plurality of metrics are influential in causing a selected metric-of-interest, the method comprising:
obtaining data for the plurality of metrics that describes visitor interaction with a website;
receiving a user selection from the plurality of metrics of a metric-of-interest that describes particular visitor interaction with the website, the user selection initiating that driving metrics are to be identified from the plurality of metrics for the metric-of-interest, the driving metrics describing other visitor interaction with the website that is influential in causing the particular visitor interaction;
identifying the driving metrics from the data by the computing device, the driving metrics identified based on application to the data of a feature selection technique to ascertain from the plurality of metrics, candidate driving metrics that are likely to be influential in causing the metric-of-interest, and application of a statistical causality technique to identify the candidate driving metrics that are determined to be influential in causing the metric-of-interest as the driving metrics; and
generating a graphical user interface by the computing device to present the driving metrics.

2. A method as described in claim 1, wherein the feature selection technique is LASSO feature selection.

3. A method as described in claim 1, wherein the statistical causality technique is Granger Causality.

4. A method as described in claim 1, wherein the graphical user interface includes a causal relationship graph having:
nodes that represent the metric-of-interest and the driving metrics; and
directed edges between the nodes, a directed edge indicating that a metric represented by a node at an origin of the directed edge is determined to be influential in causing a metric represented by a node at a termination of the directed edge.

5. A method as described in claim 4, wherein the causal relationship graph further includes a numerical weight with each of the directed edges that indicates an amount that the metric represented by the node at the origin of the directed edge is determined to influence the metric represented by the node at the termination of the directed edge.

6. A method as described in claim 1, wherein the graphical user interface includes a table that lists the driving metrics with numbers that indicate a relative amount of influence the driving metrics have in causing the metric-of-interest.

7. A method as described in claim 6, wherein the table lists the driving metrics in order of the relative amount of influence the driving metrics have in causing the metric-of-interest.

8. A method as described in claim 6, wherein a larger number indicates a greater amount of influence in causing the metric-of-interest than a smaller number.

9. A method as described in claim 1, wherein identifying the driving metrics from the data includes:
building a first model based on the metric-of-interest;
building a second model based on the metric-of-interest and the candidate driving metrics ascertained according to the feature selection technique; and
determining whether the candidate driving metrics are influential in causing the metric-of-interest based on the application of the statistical causality technique to the first and second models.

10. A method as described in claim 9, wherein the application of the statistical causality technique to the first and second models includes comparing a fit of the first and second models to the data for the plurality of metrics.

11. A method as described in claim 10, wherein a comparison that indicates the second model fits the data for the plurality of metrics closer than the first model results in identification of the candidate driving metrics as the driving metrics.

12. A method as described in claim 10, wherein a comparison that indicates the first model fits the data for the plurality of metrics closer than the second model or fits the data equally as close as the second model results in the candidate driving metrics not being identified as the driving metrics.

13. A method as described in claim 12, further comprising applying the feature selection technique to ascertain from the plurality of metrics other candidate driving metrics that are likely to be influential in causing the metric of influence.

14. A method as described in claim 1, wherein data for the plurality of metrics is obtained via one or more web analytics techniques.

15. A method implemented by a computing device to indicate which of a plurality of metrics are influential in causing a selected metric-of-interest, the method comprising:
obtaining data for the plurality of metrics that describes visitor interaction with a website over a period of time spanning at least from a first time to a second time;
receiving a user selection from the plurality of metrics of a metric-of-interest that describes particular visitor interaction with the website over the period of time;
generating a first causal relationship graph by the computing device that is associated with the first time, the first causal relationship graph indicating which of the plurality of metrics are identified as driving metrics in association with the first time, the driving metrics describing visitor interaction with the website that is influential in causing the particular visitor interaction;
generating a second causal relationship graph by the computing device that is associated with the second time, the second causal relationship graph indicating which of the plurality of metrics are identified as the driving metrics in association with the second time;
comparing the first causal relationship graph and the second causal relationship graph to ascertain differences in the driving metrics indicated by the first causal relationship graph and the second causal relationship graph; and
generating a graphical user interface by the computing device that indicates the differences in the driving metrics between the first and second causal relationship graphs.

16. A method as described in claim 15, further comprising computing a change in influence of the driving metrics on the metric-of-interest between the first and second causal relationship graphs, including:
ascertaining the driving metrics that are represented in the first causal relationship graph but are not represented in the second causal relationship graph;
identifying the driving metrics that are represented in the second causal relationship graph but are not represented in the first causal relationship graph; and
computing the change by adding an amount of influence that each of the driving metrics identified as being represented in one of the first or second causal relationship graphs but not in the other is determined to have in causing the metric-of-interest.

17. A method as described in claim 15, wherein the generating is performed responsive to receiving the user selection of the metric-of-interest and a user indication of the first time and the second time, the user indication of the first time and the second time indicating that the differences in the driving metrics identified for the metric-of-interest between the first time and the second time are to be determined.

18. A system implemented in a digital environment to indicate which of a plurality of metrics are influential in causing a selected metric-of-interest, the system comprising:
a processing system to implement a driving metric module that is configured to:
generate a user interface that enables a user to select from a plurality of metrics that describes visitor interaction with the website a metric-of-interest that describes particular visitor interaction with the website, the user selection indicating that driving metrics are to be identified from the plurality of metrics for the metric-of-interest, the driving metrics describing other visitor interaction with the website that is influential in causing the particular visitor interaction; and
generate a causal relationship graph for display via the user interface without receiving user interaction other than the user selection to select the metric-of-interest, the causal relationship graph generated to include nodes that represent the metric-of-interest and the driving metrics, and further to include weights used to determine an amount the driving metrics influence the metric-of-interest.

19. A system as described in claim 18, wherein the driving metric module is further configured to process the plurality of metrics according to LASSO feature selection and Granger Causality to identify the driving metrics for generation of the causal relationship graph, the plurality of metrics processed according to LASSO feature selection to ascertain from the plurality of metrics candidate driving metrics that are likely to be influential in causing the metric-of-interest, and the plurality of metrics processed according to Granger causality to determine whether the candidate driving metrics are influential in causing the metric-of-interest.

20. A system as described in claim 18, wherein the plurality of metrics are collected by one or more web analytics services and the driving metric module is configured to access data indicative of the plurality of metrics via the one or more web analytics services.
